(19) United States
(12) Patent Application Publication
(10) Pub. No.: US 2026/0243634 A1
(43) Pub. Date: Aug. 20, 2026

(54) Rapid Expansion Microscopy Methods and Reagents

(71) Applicant: CARNEGIE MELLON UNIVERSITY, Pittsburgh, PA (US)

(72) Inventors: Yongxin Zhao, Sewickley, PA (US); Aleksandra Klimas, Pittsburgh, PA (US); Zhangyu Cheng, Pittsburgh, PA (US); Quang Long Nguyen, Pittsburgh, PA (US)

(21) Appl. No.: 19/156,175

(22) PCT Filed: Feb. 13, 2024
(86) PCT No.: PCT/IB2024/051346

§ 371 Date: Aug. 13, 2025

Related U.S. Application Data
(60) Provisional application No. 63/445,319, filed on Feb. 14, 2023.
(60) Provisional application No. 63/531,114, filed on Aug. 7, 2023.

(51) Int. Cl. G01N 1/36; G01N 1/44

(52) U.S. Cl. CPC G01N 1/36; G01N 1/44; G01N 2001/364

(57) ABSTRACT

Methods are provided for rapid processing of tissue samples, including thick tissue, organs, and organisms, for expansion microscopy.

### CROSS REFERENCE TO RELATED APPLICATIONS

This application claims priority to U.S. Provisional Patent Application No. 63/445,319 filed Feb. 14, 2023, and U.S. Provisional Patent Application No. 63/531,114, filed Aug. 7, 2023, each of which is incorporated herein by reference in its entirety.

### STATEMENT REGARDING FEDERAL FUNDING

This invention was made with United States government support under EB028111 awarded by the National Institutes of Health. The U.S. government has certain rights in the invention.

### FIELD OF INVENTION

The present invention relates to optical imaging, such as by expansion microscopy, labelling, and analysis, of cells, whole organisms, and tissues.

### BACKGROUND

Small structures (e.g., biomolecules, proteins, DNA and/or RNA) within fixed cells and tissues are often too small for successful optical microscopic imaging. Expansion microscopy enables super-resolution optical interrogations and overcomes the optical diffraction limit of conventional optical microscopy. It was developed to allow for the imaging of thick, preserved specimens with approximately 70 nm lateral resolution. With expansion microscopy, a biological specimen is expanded prior to imaging, bringing previously sub-diffraction limited structures to a size within the range of a conventional microscope with nanoscale precision. Examples of expansion microscopy are described in, without limitation International Patent Application Publication Nos. WO 2015/127183, WO 2017/027368, WO 2017/027367, and WO 2017/147435, and in Zhao et al, Nature Biotechnology, 35, 757-764, each of which is incorporated herein by reference for its technical teachings regarding expansion microscopy.

With expansion microscopy, fluorophore-labeled biomolecules, may be locked into a swellable hydrogel that is synthesized within the sample. The gel integrates with both the biological specimen and the fluorophore-labeled biomolecules. In current systems, fluorophores may be specific to one or more biomolecules, proteins, DNAs, and/or RNAs of interest, and gel-anchorable fluorophores may be specific to one or more biomolecules, proteins, DNAs, and/or RNAs of interest, and comprise a chemical group that can interact with the polymerized gel matrix. Gel-anchoring fluorophores are often custom-made for use as an appropriate anchoring agent for the desired biomolecule, protein, DNA, and/or RNA. Three-dimensional multiplex images can also be collected through the simultaneous use of several, different fluorophore labels. Following biomolecule labeling, the gelled-biological specimens may be treated with protease to digest tissue material and to homogenize the mechanical properties of the gel. The swellable gels are then hydrated to facilitate uniform, e.g., isotropic, expansion of the gel-specimen matrix and precise migration of fluorescent labels with their targets.

While expansion microscopy to date has shown promise, improvements in speed, efficiency, ability to image thick tissue samples, ability to image a variety or tissue, organ, or whole-organism samples, and flexibility of treatments are desirable.

### SUMMARY

A method of preparing a cell or tissue sample for microscopy is provided. The method comprises: permeating the cell or tissue sample with a polymer monomer composition comprising an α,β-unsaturated carbonyl monomer for producing a water-swellable (co)polymer and a polymerization initiator compound; polymerizing the polymer monomer composition to produce a water-swellable polymer; after formation of the water-swellable polymer and before swelling the sample, homogenizing mechanical properties of the cell or tissue sample in a homogenization mixture comprising a chaotropic agent at a pressure greater than 1 atm and at a temperature over 100° C.; and swelling the water-swellable polymer to expand the cell or tissue sample. A method of producing a high-resolution microscopic image of a cell or tissue sample comprising preparing a cell or tissue sample according to the method of preparing a cell or tissue sample for microscopy and imaging the cell or tissue sample.

According to another aspect of the invention, a kit for use in expansion microscopy is provided. The kit comprises, in packaging, an α,β-unsaturated carbonyl monomer for producing a water-swellable (co)polymer, a chaotropic agent, such as urea, and a polymerization initiator, such as a UV photoinitiator, packaged in one or more vessels, and optionally, a microscope slide and/or a form for use in forming an water-swellable sample comprising the monomer, for expansion microscopy.

The following numbered clauses describe various aspects, embodiments, and/or examples of the present invention.
Clause 1. A method of preparing a cell or tissue sample for microscopy, comprising:
permeating the cell or tissue sample with a polymer monomer composition comprising an α,β-unsaturated carbonyl monomer for producing a water-swellable (co)polymer and a polymerization initiator compound;
polymerizing the polymer monomer composition to produce a water-swellable polymer;
after formation of the water-swellable polymer and before swelling the sample, homogenizing mechanical properties of the cell or tissue sample in a homogenization mixture comprising a chaotropic agent at a pressure greater than 1 atm and at a temperature over 100° C.; and
swelling the water-swellable polymer to expand the cell or tissue sample.
Clause 2. The method of clause 1, wherein the polymer monomer composition further comprises an enal able to polymerize with the α,β-unsaturated carbonyl monomer; and polymerizing the polymer monomer composition with the enal to form a swellable material containing the cell or tissue sample, resulting in covalent linking of the enal to both the swellable material and a biomaterial in the sample.
Clause 3. The method of clause 3, wherein the enal comprises acrolein or methacrolein.
Clause 4. The method of clause 3, wherein the enal comprises a compound having the structure

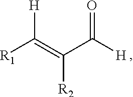

where R₁ and R₂ are, independently: H, C₁-C₃ alkyl, C₁-C₃ haloalkyl, C₁-C₃ alkyl-aryl, or C₁-C₃ halo alkyl-aryl.
Clause 5. The method of any one of clauses 1-4, wherein the wherein the α,β-unsaturated carbonyl monomer comprises acrylic acid, an acrylate, methacrylic acid, a methyacrylate, acrylamide, and/or methacrylamide.
Clause 6. The method of any one of clauses 1-5, wherein the polymer monomer composition comprises a crosslinker, such as N,N′ methylene-bis(acrylamide).
Clause 7. The method of clause 6, comprising from 0.01 g/100 mL to 5 g/100 mL of the crosslinker.
Clause 8. The method of clause 1, wherein the homogenization mixture further comprises a protease, a surfactant, 2-mercaptoethanol and/or DTT, and/or a chelating agent.
Clause 9. The method of any one of clauses 1-8, wherein the polymerization initiator compound is a photoinitiator.
Clause 10. The method of clause 9, wherein the photoinitiator is a UV photoinitiator.
Clause 11. The method of clause 9, wherein the photoinitiator comprises 2-Hydroxy-4′-(2-hydroxyethoxy)-2-methylpropiophenone, 2-Benzyl-2-(dimethylamino)-4′-morpholinobutyrophenone, 2,2-Dimethoxy-2-phenylacetophenone, and/or 2-Hydroxy-2-methyl-1-phenylpropanone, or any combination of the preceding.
Clause 12. The method of any one of clauses 1-11, wherein the sample is a whole organism or embryo.
Clause 13. The method of any one of clauses 1-11, wherein the sample comprises a plurality of organs of an organism.
Clause 14. The method of clause 1, wherein the cell or tissue sample is a tissue section.
Clause 15. The method of clause 14, wherein the tissue section is provided mounted with a coverslip and/or paraffin-embedded, and the method further comprises pre-processing the tissue section with an organic solvent, such as xylene, to remove the coverslip and/or paraffin from the sample and replacing the organic solvent with an aqueous solution.
Clause 16. The method of any one of clauses 1-15, further comprising staining the sample, such as with a DAPI stain.
Clause 17. The method of any one of clauses 1-16, further comprising, prior to permeating with the polymer monomer composition, after polymerizing the polymer monomer composition, or after hydrating the sample, labeling a biomolecule of the sample with a detectable ligand, such as an immunofluorescence label or an immunohistochemistry label.
Clause 18. The method of clause 17, wherein the detectable ligand is a dye-conjugated or enzyme-conjugated ligand.
Clause 19. The method of clause 18, wherein the detectable ligand is a dye-conjugated ligand comprising a fluorescent dye.
Clause 20. The method of clause 17, wherein the detectable ligand is an antibody, an antibody fragment, an antibody mimetic, a nucleic acid, or a nucleic acid analog.
Clause 21. The method of any one of clauses 1-20, wherein during swelling, the sample swells isotropically, thereby maintaining the relative spatial relationship of biomolecules in the sample.
Clause 22 The method of clause 1, wherein the cell or tissue sample is fixed in a fixative, further comprising removing the fixative from the sample by exposing the sample to a solvent for the fixative prior to permeating the cell or tissue sample with the polymer monomer composition.
Clause 23. The method of clause 1, comprising:
permeating the cell or tissue sample with a polymer monomer composition comprising sodium acrylate, acrylamide, N,N′-methylene bis(acrylamide), and acrolein or methacrolein;
polymerizing the polymer monomer composition within the sample to form a swellable material, resulting in covalent linking of the acrolein or methacrolein to both the swellable material and biomaterials in the sample;
homogenizing the mechanical properties of the cell or tissue sample in a homogenization mixture comprising a chaotropic agent at a pressure greater than 1 atm and at a temperature over 100° C.; and
hydrating the sample to cause the swellable material to physically expand.
Clause 24. The method of clause 2, wherein the polymer monomer composition comprises from 0.5M to 6M of α,β-unsaturated carbonyl monomer and/or from 0.01 g/100 mL to 10 g/100 mL of the enal.
Clause 25. The method of clause 1, wherein the sample comprises an organism having a cell wall, further comprising, after polymerizing the polymer monomer composition and before hydrating the sample, enzymatically-digesting the cell wall of the organism.
Clause 26. The method of clause 25, wherein the cell wall of the organism is digested with a glucanase or cellulase, such as lyticase, chitinase, or lysozyme.
Clause 27. The method of any one of clauses 1-26, wherein the chaeotropic agent is urea.
Clause 28. The method of any one of clauses 1-27, wherein the homogenization is performed at a pressure ranging from 2 to 20 psi above ambient atmospheric pressure (e.g., ranging from 29.6 to 30.2 inches Hg or from 14.53 to 14.84 psi, e.g., 29.9 inches Hg or 14.69 psi), or ranging from 3-15 psi above ambient atmospheric pressure.
Clause 29. The method of any one of clauses 1-28, wherein the homogenization is performed at a temperature ranging from 120° C. to 135° C.
Clause 30 The method of any one of clauses 1-29, wherein the homogenization is conducted for a length of time, at a pressure, and at a temperature such that detectable features of the tissue or cell to be evaluated, such as structural, antigenic, or chemical features of the tissue or cell to be evaluated, are preserved.
Clause 31. The method of any one of clauses 1-30, wherein the homogenization is performed in an autoclave.
Clause 32. A method of producing a high-resolution microscopic image of a cell or tissue sample comprising preparing a cell or tissue sample according to the method of any one of clauses 1-31 and imaging the cell or tissue sample.
Clause 33. A kit for use in expansion microscopy, comprising, in packaging, an α,β-unsaturated carbonyl monomer for producing a water-swellable (co)polymer, a chaotropic agent, such as urea, and a polymerization initiator, such as a UV photoinitiator, packaged in one or more vessels, and optionally, a microscope slide and/or a form for use in forming an water-swellable sample comprising the monomer, for expansion microscopy.

### BRIEF DESCRIPTION OF THE DRAWINGS

FIG. 1. Fluorescence Microscopy Images for human lymph node FFPE samples, before and after gelling with UV protocol. Images were taken at 20× magnification. Tissues were stained with DAPI (blue), ATPIF1 (green), Vimentin (red), and Pan-Cytokeratin (magenta). (a) Representative view of human lymph node on FFPE slide (pre-expansion). (b) Representative view of human lymph node after gelling with UV protocol (post-expansion).

FIG. 2. Fluorescence Microscopy Images for EVs expanded by UV protocol. (a) Representative view of EVs that were stained with DAPI (cyan) and 18s rRNA FISH (magenta). (b) Representative view of EVs that were stained with LEL (green), Dil (red), and NHS-Cy5 (magenta). (c) Representative view of EVs that were stained with DAPI (cyan), PD-L1 antibody (yellow), and Tsg101 antibody (magenta). Scales: 1 μm (biological scales).

FIG. 3. Fluorescent image of expanded platelets. Stain: Green, Wheat Germ Agglutinin; Red, pan-protein stain; Purple, Lipid stain DiD. Scale bar, 4 μm (biological scale, expansion factor 8×).

FIG. 4. The schematics of the process and chemistry that covalently incorporates biomolecules into polymer chains during in situ polymerization.

FIG. 5. Expansion and imaging of an FFPE human kidney sample. FFPE human kidney tissue was treated with the rapid Magnify approach and stained with DAPI (blue), ACTN4 (green), and Vimentin (red) and fully expanded in water. Images were taken at (A) 10× and (B) 60×.

FIG. 6. Expansion and imaging of a zebrafish embryo. A 5-day post fertilization zebrafish embryo was treated with the rapid Magnify approach and stained with DAPI (blue) and INA (green). It was expanded in 1×PBS and imaged at 10× magnification.

FIG. 7. Expansion of a mouse heart. (A) A 4% PFA fixed mouse heart was treated with the rapid Magnify approach (B) and stained with NHS-Cy3 and expanded in 1:50 PBS (C).

### DETAILED DESCRIPTION

The use of numerical values in the various ranges specified in this application, unless expressly indicated otherwise, are stated as approximations as though the minimum and maximum values within the stated ranges are both preceded by the word “about”. In this manner, slight variations above and below the stated ranges can be used to achieve substantially the same results as values within the ranges. Also, unless indicated otherwise, the disclosure of ranges is intended as a continuous range including every value between the minimum and maximum values. As used herein “a” and “an” refer to one or more. A patient is a human or non-human animal.

As used herein, the term “comprising” is open-ended and may be synonymous with “including”, “containing”, or “characterized by”. As used herein, embodiments “comprising” one or more stated elements or steps also include but are not limited to embodiments “consisting essentially of” and “consisting of” these stated elements or steps.

A “moiety” (pl. “moieties”) is a part of a chemical compound, and includes groups, such as functional groups. As such, a nucleobase moiety is a nucleobase that is modified by attachment to another compound moiety, such as a polymer monomer, e.g. the nucleic acid or nucleic acid analog monomers described herein, or a polymer, such as a nucleic acid or nucleic acid analog as described herein.

“Alkyl” refers to straight, branched chain, or cyclic hydrocarbon groups including from 1 to about 20 carbon atoms, for example and without limitation C₁₋₃, C₁₋₆, C₁₋₁₀ groups, for example and without limitation, straight, branched chain alkyl groups such as methyl, ethyl, propyl, butyl, pentyl, hexyl, heptyl, octyl, nonyl, decyl, undecyl, dodecyl, and the like. “Substituted alkyl” refers to alkyl substituted at 1 or more, e.g., 1, 2, 3, 4, 5, or even 6 positions, which substituents are attached at any available atom to produce a stable compound, with substitution as described herein. “Optionally substituted alkyl” refers to alkyl or substituted alkyl. “Halogen,” “halide,” and “halo” refers to —F, —Cl, —Br, and/or —I. “Alkylene” and “substituted alkylene” refer to divalent alkyl and divalent substituted alkyl, respectively, including, without limitation, ethylene (—CH₂—CH₂—). “Optionally substituted alkylene” refers to alkylene or substituted alkylene. Alkene and alkyne, and similar designations have art-recognized meaning.

“Aryl,” alone or in combination refers to an aromatic ring system such as phenyl or naphthyl. “Aryl” also can include aromatic ring systems that are optionally fused with a cycloalkyl ring. A “substituted aryl” is an aryl that is independently substituted with one or more substituents attached at any available atom to produce a stable compound, wherein the substituents are as described herein. The substituents can be, for example, hydrocarbyl groups, alkyl groups, alkoxy groups, and halogen atoms. “Optionally substituted aryl” refers to aryl or substituted aryl. An aryloxy group can be, for example, an oxygen atom substituted with any aryl group, such as phenoxy. An arylalkoxy group can be, for example, an oxygen atom substituted with any aralkyl group, such as benzyloxy. “Arylene” denotes divalent aryl, and “substituted arylene” refers to divalent substituted aryl. “Optionally substituted arylene” refers to arylene or substituted arylene. A “polycyclic aryl group” and related terms, such as “polycyclic aromatic group” refers to a group composed of at least two fused aromatic rings. “Heteroaryl” or “hetero-substituted aryl” refers to an aryl group substituted with one or more heteroatoms, such as N, O, P, and/or S. Examples of heteroaryl groups include, but are not limited to, thienyl, furyl, pyridyl, oxazolyl, quinolyl, thiophenyl, isoquinolyl, indolyl, triazinyl, triazolyl, isothiazolyl, isoxazolyl, imidazolyl, benzothiazolyl, pyrazinyl, pyrimidinyl, thiazolyl, and thiadiazolyl.

“PEG” refers to polyethylene glycol. “PEGylated” refers to a compound comprising a moiety, comprising two or more consecutive ethylene glycol moieties. Non-limiting examples of PEG moieties for PEGylation of a compound include, one or more blocks of from 1 to 200 ethylene glycol units, such as —(O—CH₂—CH₂)ₙ—, —(CH₂—CH₂—O)ₙ—, or —(O—CH₂—CH₂)ₙ—OH, where n ranges, for example and without limitation, from 1 to 200 or from 1 to 100, for example from 1 to 5, or 1.

“Cycloalkyl” refers to monocyclic, bicyclic, tricyclic, or polycyclic, 3- to 14-membered ring systems, which are either saturated, or partially unsaturated. The cycloalkyl group may be attached via any atom. Cycloalkyl also contemplates fused rings wherein the cycloalkyl is fused to an aryl or heteroaryl ring. Representative examples of cycloalkyl include, but are not limited to cyclopropyl, cyclobutyl, cyclopentyl, and cyclohexyl. A cycloalkyl group can be unsubstituted or optionally substituted with one or more substituents as described herein below. “Cycloalkylene” refers to divalent cycloalkyl. The term “optionally substituted cycloalkylene” refers to cycloalkylene that is substituted with at least 1, 2 or 3 substituents, attached at any available atom to produce a stable compound, wherein the substituents are as described herein.

Terms combining the foregoing refer to any suitable combination of the foregoing, such as arylalkenyl, arylalkynyl, heteroarylalkyl, heteroarylalkenyl, heteroarylalkynyl, heterocyclylalkyl, heterocyclylalkenyl, heterocyclylalkynyl, heteroaryl, heterocyclyl, cycloalkyl, cycloalkenyl, alkylarylalkyl, alkylarylalkenyl, alkylarylalkynyl, alkenylarylalkyl, alkenylarylalkenyl, alkenylarylalkynyl, alkynylarylalkyl, alkynylarylalkenyl, alkynylarylalkynyl, alkylheteroarylalkyl, alkylheteroarylalkenyl, alkylheteroarylalkynyl, alkenylheteroarylalkyl, alkenylheteroarylalkenyl, alkenylheteroarylalkynyl, alkynylheteroarylalkyl, alkynylheteroarylalkenyl, alkynylheteroarylalkynyl, alkylheterocyclylalkyl, alkylheterocyclylalkenyl, alkylhererocyclylalkynyl, alkenylheterocyclylalkyl, alkenylheterocyclylalkenyl, alkenylheterocyclylalkynyl, alkynylheterocyclylalkyl, alkynylheterocyclylalkenyl, alkynylheterocyclylalkynyl, alkylaryl, alkenylaryl, alkynylaryl, alkylheteroaryl, alkenylheteroaryl, and alkynylhereroaryl. As an example, “arylalkylene” refers to a divalent alkylene wherein one or more hydrogen atoms in an alkylene group is replaced by an aryl group, such as a (C₃-C₈) aryl group. Examples of (C₃-C₈) aryl-(C₁-C₆)alkylene groups include, without limitation: 1-phenylbutylene, phenyl-2-butylene, I-phenyl-2-methylpropylene, phenylmethylene, phenylpropylene, and naphthylethylene. The term “(C₃-C₅) cycloalkyl-(C₁-C₆)alkylene” refers to a divalent alkylene wherein one or more hydrogen atoms in the C₁-C₆ alkylene group is replaced by a (C₃-C₈) cycloalkyl group. Examples of (C₃-C₈) cycloalkyl-(C₁-C₆)alkylene groups include without limitation 1-cycloproylbutylene, cycloproyl-2-butylene, cyclopentyl-1-phenyl-2-methylpropylene, cyclobutylmethylene and cyclohexylpropylene.

Chaotropic agents are compounds or compositions able to disrupt hydrogen bonding in solution, examples of which include, without limitation: n-butanol, ethanol, guanidinium chloride, lithium perchlorate, sodium doxycholate, lithium acetate, magnesium chloride, phenol, 2-propanol, thiourea, and urea.

As used herein, the term “polymer composition” is a composition comprising one or more polymers. As a class, “polymers” includes, without limitation, homopolymers, heteropolymers, co-polymers, block polymers, block co-polymers and can be both natural and/or synthetic. Homopolymers contain one type of building block, or monomer, whereas copolymers contain more than one type of monomer. The term “(co)polymer” and like terms refer to either homopolymers or copolymers. A polymer may have any shape for the chain making up the backbone of the polymer, including, without limitation: linear, branched, networked, star, brush, comb, or dendritic shapes.

A polymer “comprises” or is “derived from” a stated monomer if that monomer is incorporated into the polymer. Thus, the incorporated monomer (monomer residue) that the polymer comprises is not the same as the monomer prior to incorporation into a polymer, in that at the very least, certain groups/moieties are missing and/or modified when incorporated into the polymer backbone. A polymer is said to comprise a specific type of linkage if that linkage is present in the polymer, such as, without limitation: ester, amide, carbonyl, ether, thioester, thioether, disulfide, sulfonyl, amine, carbonyl, or carbamate bonds.

The term “ligand” refers to a binding moiety for a specific target, its binding partner. The molecule can be a cognate receptor, a protein, a small molecule, a hapten, or any other relevant molecule, such as an affibody or a paratope-containing molecule. The term “antibody”, for ease of reference and unless otherwise specified, refers to an immunoglobulin, derivatives thereof which maintain specific binding ability, and proteins having a binding domain which is homologous or largely homologous to an immunoglobulin binding domain, and complexes thereof. As such, the antibody operates as a ligand for its cognate antigen, which can be virtually any molecule. Natural antibodies typically comprise two heavy chains and two light chains and are bi-valent. The interaction between the variable regions of heavy and light chain forms a binding site capable of specifically binding an antigen (e.g., a paratope). The term “V_{H}” refers to a heavy chain variable region of an antibody. The term “V_{L}” refers to a light chain variable region of an antibody. Antibodies may be derived from natural sources, or partly or wholly synthetically produced. An antibody may be monoclonal or polyclonal. The antibody may be a member of any immunoglobulin class, including, for example and without limitation, any of the human classes: IgG, IgM, IgA, IgD, and IgE.

An antibody may be a monoclonal antibody, including fragments, derivatives, or analogs thereof, or complexes thereof, including without limitation: Fab, Fab′, Fv fragments, single chain Fv (scFv) fragments, dsFv, Fabi fragments, F(ab′)₂ fragments, single domain antibodies, camelized antibodies and antibody fragments, humanized antibodies and antibody fragments, and multivalent versions of the foregoing; multivalent binding reagents including without limitation: monospecific or bispecific antibodies, such as disulfide stabilized Fv fragments, scFv tandems ((ScFv)₂ fragments), diabodies, triabodies, tetrabodies, which typically are covalently linked or otherwise stabilized (e.g., leucine zipper or helix stabilized) scFv fragments, bi-specific T-cell engager (BiTE), di-scFv (dimeric single-chain variable fragment), single-domain antibody (sdAb), or antibody binding domain fragments. Antibody fragments also include miniaturized antibodies or other engineered binding reagents that exploit the modular nature of antibody structure, comprising, often as a single chain, one or more antigen-binding or epitope-binding (e.g., paratope) sequences and, at a minimum, any other amino acid sequences needed to ensure appropriate specificity, delivery, and stability of the composition.

Antibodies may be produced by any effective method, such as by hybridoma or it may be recombinantly or synthetically produced. In the context of the present disclosure and for ease of reference, “antibodies” or “antibody” may refer to both natural antibodies as well as protein antibody analogs, antibody fragments, and derivatives comprising VL and VH sequences and/or CDRs (complementarity Determining region, e.g., all six CDRs of any VH or VL combination).

Ligands also include other engineered binding reagents, such as affibodies and designed ankyrin repeat proteins (DARPins), that exploit the modular nature of repeat proteins (Forrer T, Stumpp M T, Binz H K, Plückthun A: A novel strategy to design binding molecules harnessing the modular nature of repeat proteins, FEBS Lett 2003, 539:2-6; Gebauer A, Skerra A: Engineered protein scaffolds as next-generation antibody therapeutics, Curr Opin Chem Biol 2009, 13:245-255), comprising, often as a single chain, one or more antigen-binding or epitope-binding sequences and at a minimum any other amino acid sequences needed to ensure appropriate specificity, delivery, and stability of the composition (see also, e.g., Nelson, A L, “Antibody Fragments Hope and Hype” (2010) MAbs 2 (1): 77-83).

Nucleic acid analogs hybridize to nucleic acids, and may have standard nucleobases (e.g., adenine, cytosine, thymine, uracil, and guanine), or other nucleobases as RNA or DNA as found in living organisms, but have different polymeric backbones as compared to include, for example and without limitation: phosphorothioate DNA, peptide nucleic acid, α,β-constrained nucleic acid, 2′-methoxyl RNA, 2′-fluoro RNA, phosphorodiamidate morpholino oligomer, locked nucleic acid, 2′,4′-constrained ethyl nucleic acid, 2′,4′ bridged nucleic acid NC (N—H), 2′,4′ bridged nucleic acid NC (N-methyl), ((S)-5′-C-methyl DNA (RNA)), and 5′-E-vinylphosphonate nucleic acid. In the context of the present invention, ligands are useful in immunohistochemical, or immunofluorescent labeling of biomolecules in the sample.

Unless indicated otherwise, nucleic acid sequences are provided in 5′ to 3′ orientation, and amino acid sequences are provided in an N to C-terminal orientation.

A large variety of dyes, such as DAPI (which directly binds dsDNA), that label biomolecules directly, fluorescent tags, such as fluorescent dyes (e.g., fluorescein, cyanine, rhodamine, fluorescent proteins, among many other commercially-available dyes), or enzymes (e.g., horseradish peroxidase, alkaline phosphatase, glucose oxygenase, or β-galactosidase) may be conjugated with ligands, such as antibodies and antibody fragments or nucleic acids or nucleic acid analogs, for use in labeling biomolecules in a sample by any direct or indirect binding method. Antibodies and other ligands conjugated to dyes or enzymes, e.g., fluorophores, are broadly-available commercially.

Provided herein according to one embodiment or aspect of the invention is a method of preparing a cell or tissue sample for microscopy. The cell or tissue sample, which can be referred to as a specimen, may be a cell, or a cell pellet, a bodily fluid, such as blood or urine or a centrifuged pellet therein, a section prepared, e.g., by use of a microtome, a biopsy, an organ, a plurality of organs or a portion of a whole organism, or a whole organism, including an embryo or larva. A section may be prepared from fixed and/or frozen tissue, e.g. by use of a microtome or cryostat. The sample may be fixed using a fixative, such as formaldehyde and embedded in paraffin, OCT or another suitable composition.

A cell or tissue sample may be processed directly, optionally after fixation, e.g., with acetone, but if it is mounted in paraffin, OCT, or other embedding materials, those materials may be removed using appropriate solvent(s), ultimately to provide the cell or tissue sample in an aqueous solution, such as PBS, saline, or water, that is permissive to polymerization of acrylic or acrylamide polymers. For example, and without limitation, for a formaldehyde-fixed sample embedded in paraffin, deparaffinizing the sample, e.g., by sequential washes with an organic solvent, such as xylene, followed by one or more washes with ethanol and water. In one non-limiting example, for deparaffinizing a sample, washes of xylene (2×), 100% ethanol (2×), 95% ethanol, 70% ethanol, 50% ethanol, and water may be performed, in order. Permanently-mounted slides may be pre-processed in the same manner, or in a similar manner. OCT fixative may be solubilized in PBS, and unfixed, frozen samples may be fixed in acetone. Prior to permeabilization with polymer monomers, the sample may be further processed, e.g., by heat treatment, for example at 60° C. for 30 minutes. The sample also may be treated with a surfactant.

The cell or tissue sample may then be permeated with (infused with) a swellable material. In one embodiment, the cell or tissue sample is permeated with (infused with) a polymer monomer composition. This is accomplished by immersing the sample in a solution containing suitable polymer monomers or otherwise applying the solution to the sample. For expansion microscopy, the monomers result in a water-swellable polymer composition. Water-swellable hydrophilic polymers can absorb several times their weight of water or aqueous liquids, such as urine or blood, and are therefore commonly employed as absorbents, for example in hygiene articles such as diapers for babies and incontinence pants for adults, tampons, and the like. Useful water-swellable monomers for producing a water-swellable (co)polymer include any monomer that, when polymerized as a (co)polymer, produces a water-swellable polymer. Water-swellable (co)polymers are often made by initially polymerizing α,β-unsaturated carbonyl monomers, such as unsaturated carboxylic acids, or derivatives thereof, such as, for example, acrylates, such as acrylic acid, alkali metal (e.g., sodium and/or potassium) or ammonium salts of acrylic acid or other acrylates, alkyl acrylates such as methacrylate, and the like, and/or acrylamides, such acrylamide, alkylacrylamides, methacrylamide, and/or N,N-dimethylacrylamide. The monomers are polymerized in the presence of relatively small amounts of di- or poly-functional monomers (crosslinkers, or multi-functional monomers), such as N,N′-methylenebisacrylamide, N,N′-bisacryloyl-1,2-dihydroxy-1,2-ethylenediamine, N,N′-ethylenebis(acrylamide), trimethylolpropane triacrylate, ethylene glycol di(meth)acrylate, or triallylamine. When N,N-dimethylacrylamide is used in high concentrations, such as if it is used as a monomer for the primary polymer, it also may act as a crosslinker (see, e.g., Cipriano, B H, et al. Superabsorbent Hydrogels That Are Robust and Highly Stretchable. Macromolecules 2014 47 (13): 4445-4452). The di- or poly-functional monomer materials serve to lightly cross-link the polymer chains thereby rendering them water-insoluble, yet water-swellable. These lightly-crosslinked absorbent polymers contain a multiplicity of carboxylate groups attached to the polymer backbone.

In a typical polymerization mixture, the concentration of α,β-unsaturated carbonyl monomers, may be from 1 g/100 mL to the saturated concentration, such as from 1 g/100 mL to 35 g/100 mL. The total molar concentration of α,β-unsaturated carbonyl monomers, may be from 0.5 M to 6 M. The concentration of crosslinkers, such as N,N′-methylene bis(acrylamide), may be from 0.01 g/100 mL to 5 g/100 mL. The concentration of enal, such as acrolein or methacrolein, may be from 0.01 g/100 mL to 10 g/100 mL. When combined in a typical polymerization mixture, the concentration of acrylate monomer may be from 5 g/100 mL to 35 g/100 mL, the concentration of acrylamide monomer may be from 0 g/100 mL to 5 g/100 mL, the concentration of N,N-dimethylacrylamide may be from 0 g/100 mL to 35 g/100 mL. The total molar concentration of α,β-unsaturated carbonyl monomers, may be from 1 M to 5 M. The concentration of crosslinkers, such as N,N′-methylene bis(acrylamide), may be from 0.1 g/100 mL to 0.2 g/100 mL. The concentration of enal, such as acrolein or methacrolein, may be from 0.05 g/100 mL to 5 g/100 mL.

α,β-unsaturated carbonyl monomers include, for example and without limitation: acrylic acids and alkali metal salts thereof, e.g., acrylic acid, methacrylic acid, α-chloroacrylic acid, α-cyanoacrylic acid, acrylamide, methacrylamide, N,N-dimethylacrylamide, β-methylacrylic acid (crotonic acid), α-phenylacrylic acid, β-acryloxypropionic acid, sorbic acid, α-chlorosorbic acid, angelic acid, cinnamic acid, p-chlorocinnamic acid, β-stearylacrylic acid, itaconic acid, citroconic acid, mesaconic acid, glutaconic acid, aconitic acid, maleic acid, fumaric acid, tricarboxyethylene, and maleic anhydride. Combinations of any of the above, forming a copolymer, also are useful, such as a combination of an alkali metal salt of an acrylate in combination with acrylamide, methacrylamide, or N,N-dimethylacrylamide.

Polymerization of monomers as described are typically performed by a radical polymerization method, and to that end a suitable polymerization initiator may be added to the polymerization mixture, and the sample is then placed under suitable conditions, such as an appropriate temperature or irradiation, to initiate and complete polymerization and cross-linking, as is desired. Although a free-radical polymerization method is used in the examples below, controlled-radical polymerization methods, such as living radical polymerization, atom-transfer radical polymerization (ATRP), Reversible Deactivation Radical Polymerization (RDRP) such as Reversible Addition Fragmentation chain Transfer (RAFT) polymerization may be substituted therefor. Any effective polymerization initiator may be utilized. The polymerization initiator may be heat-activated. Alternatively, the polymerization initiator may be a photoinitiator, such as a UV light or visible light-activated, radical polymerization photoinitiator.

In further detail, thermal polymerization initiators may include, but are not limited to, ammonium persulfate (APS), azo compounds, such as 2,2′-azobis(isobutyronitrile) (AIBN), and organic peroxides, such as benzoyl peroxide (BPO), among many others, for example as are known to those of ordinary skill in the polymerization arts.

The use of light to mediate radical polymerization has emerged as a powerful strategy for rational polymer synthesis and advanced materials fabrication. These light-mediated reactions are performed in polymerization mixtures comprising polymer monomers, such as (meth)acrylic or (meth)acrylamide monomers and a photoinitiator.

The photoinitiator initiates polymerization in the presence of light at a defined wavelength including ultraviolet (UV) and visible light. Because the methods described herein may be performed by a laboratory technician, in such instances, a UV-sensitive photoinitiator may be employed to prevent initiation under typical laboratory lighting.

Photoinitiators that initiate polymerization in the presence of ultraviolet radiation are broadly-known and may include, but are not limited to benzoin alkyl ethers, benzyl ketals, α-dialkoxy-acetophenones, α-hydroxy-alkyl-phenones, α-amino-alkyl-phenones, acyl-phosphine oxides, benzophenones, benzoamines, thioxanthones, thioamines, or combinations thereof (see e.g., Aldrich Polymer Products Application & Reference Information, Applications: Free Radical Initiators, download Nov. 14, 2023). Photoinitiators that initiate polymerization in the presence of visible light are broadly known and may include, but are not limited to titanocenes, phosphine oxides, phosphinates, diketones, oxime esters, flavonoids, Group 14 elements (e.g., silicon, germanium, tin), or combinations thereof (see e.g., Müller et al. “Recent Advances in Type I Photoinitiators for Visible Light Induced Photopolymerization”, ChemPhotoChem, 2022, 6, e202200091 and Aldrich Polymer Products Application & Reference Information, Applications: Free Radical Initiators).

For example, the photoinitiator may be a photoinitator from the IRGACURE® family of photoinitiators. Non-limiting examples of IRGACURE® photoinitiators include but are not limited to:
2-Hydroxy-4′-(2-hydroxyethoxy)-2-methylpropiophenone (IRGACURE® 2959)

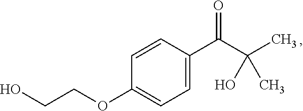 [SMILES: CC(C)(O)C(=O)c1ccc(OCCO)cc1]

2-Benzyl-2-(dimethylamino)-4′-morpholinobutyrophenone (IRGACURE® 369; I-369),

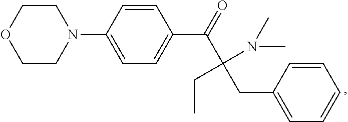 [SMILES: CCC(Cc1ccccc1)(C(=O)c1ccc(N2CCOCC2)cc1)N(C)C]

2,2-Dimethoxy-2-phenylacetophenone (DMPA; IRGACURE® 651),

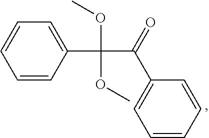 [SMILES: COC(OC)(C(=O)c1ccccc1)c1ccccc1]

2-Hydroxy-2-methyl-1-phenylpropanone (IRGACURE® 1173)

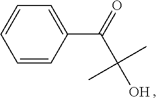

or combinations thereof.

The polymerizable composition may optionally further comprise a crosslinker, such N,N′-methylene-bis(acrylamide). The polymerizable composition may further comprise a solvent, such as water, methanol, phosphate buffered saline (PBS), or combinations thereof.

In combination with the above-described monomers, an enal (e.g.,

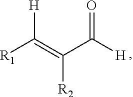

where R₁ and R₂ are, independently: H, C₁-C₃alkyl, C₁-C₃ haloalkyl, C₁-C₃ alkyl-aryl, or C₁-C₃ halo alkyl-aryl) may be added to the monomer mixture prior to polymerization along with any necessary catalysts or cofactors necessary for the polymerization to proceed. Non-limiting examples of suitable enals include acrolein and methacrolein. The enal may be infused with the monomers of the water-swellable polymer, or afterwards.

After the sample is infused with suitable monomers for preparation of a water-swellable polymer, the monomers are polymerized in situ. As such, during infusion of the monomers, or afterward, reagents necessary or useful to cause or accelerate polymerization are added, such as an initiator or catalyst, or any other reagent(s) necessary or useful for polymerizing the monomers, such as an enal, such as acrolein or methacrolein. Infusion and polymerization may take place in a suitable container or mold.

Bacteria, fungi, and plants have cell walls that prohibit traditional expansion microscopy, even with use of a protease digest. As such, alternatively, or in combination with homogenization, where the sample comprises an organism having a cell wall, the cell wall is enzymatically digested before or after infusion and polymerization and before expansion of the swellable hydrogel in the sample. Examples of enzymes useful in digestion of cell walls, include a glucanase or a cellulase, such as lyticase (e.g., from Arthrobacter luteus), Achromopeptidase, lysing Enzymes from Trichoderma harzianum, pectinase, pectolyase, lysostaphin, lysozyme, mutanolysin, and/or chitinase.

Once the polymer (hydrogel) is formed, the sample may be homogenized. Homogenization may be performed with a chaotropic agent at a temperature above 100° C. and a pressure above 1 atm, such as from 2 to 20 psi, or from 3 to 12 psi above atmospheric pressure, such as in an autoclave. Other agents, such as proteases, surfactants, reducing agents, or denaturants may be added to the sample to facilitate homogenization. The homogenization may be conducted for a length of time, at a pressure, and at a temperature such that detectable features of the tissue or cell to be evaluated, such as structural, antigenic, or chemical features of the tissue or cell to be evaluated, are preserved. For example, the detectable features of the tissue or cell to be evaluated are not substantially degraded by the application of heat and pressure over the time period such heat and pressure are applied during homogenization and/or biomolecules are denatured but without aggregation or entanglement with each other over the time period such heat and pressure are applied during homogenization. The homogenization may be performed at a temperature ranging from 120° C. to 135° C., including any increment therebetween, such as 120° C., 121° C., 122° C., 123° C., 124° C., 125° C., 126° C., 127° C., 128° C., 129° C., 130° C., 131° C., 132° C., 133° C., 134° C. or 135° C. The homogenization may be performed at a pressure ranging from 2 to 20 psi, including any increment therebetween, above ambient atmospheric pressure, e.g., ranging from 29.6 to 30.2 inches Hg or from 14.53 to 14.84 psi, e.g., 29.9 inches Hg or 14.69 psi, or ranging from 3-15 psi above ambient atmospheric pressure, such as 2 psi, 3 psi, 4 psi, 5 psi, 6 psi, 7 psi, 8 psi, 9 psi, 10 psi, 11 psi, 12 psi, 13 psi, 14 psi, 15 psi, 16 psi, 17 psi, 18 psi, 19 psi, or 20 psi above atmospheric pressure. The homogenization is performed in a homogenization solution that comprises a chaotropic agent. In one example, urea is selected as the chaotropic agent and is present in a concentration of from 2-10M, including any increment therebetween, such as 2, 3, 4, 5, 6, 7, 8, 9, or 10M, for example about 8M. Equivalent amounts of other chaotropic agents may be substituted for the urea, or effective amounts of other chaotropic agents may be included in the homogenization mixture with the urea.

The sample can be swelled, e.g., typically expanded isotropically, by hydration. Hydration involves contacting the hydrogel containing the sample with water, or a suitably low ionic strength aqueous solution to cause swelling of the polymer. Typically, the expansion factor upon hydration is at least 2, and more typically greater than 3, meaning the isotropic expansion in any linear dimension is at least 2 and is more typically greater than 3, depending on the choice of monomers, crosslinking density, among other factors.

At any suitable point in the processing of a cell or tissue sample, biomolecules may be dyed or labeled in any suitable and effective manner. In one example the sample is labeled prior to infusion or polymerization with the monomers, as described herein. In another example, the sample is labeled after polymerization, but before expansion of the sample, and optionally before protease digestion of the sample. In one example the sample is labeled after expansion. In yet another example, a biomolecule in the sample is labeled with a first label after expansion, viewed or imaged, and subsequently the first label is removed, and a second label is used to label a different biomolecule. This process may be repeated multiple times. At any stage, multiple labels may be used simultaneously, e.g., fluorescent labels with different emission spectra, to label different biomolecules in the sample. Of note, in contrast to the use of traditional expansion microscopy reagents, bonds between enal residues, when included, and the biomolecules in the expanded cell or tissue sample can reverse over time, exposing additional epitopes or binding sites, thereby expanding the ability to visualize biomolecules in the sample.

Also provided herein is a kit for use in expansion microscopy. A kit comprises various components that are packaged for storage, transport, and distribution in any suitable container (e.g., packaging). A kit for use in expansion microscopy methods may comprise one or more vessels. In a vessel, in one embodiment, is a mixture of monomers for producing a water-swellable polymer, and in the same vessel, or in another vessel optionally is an enal, such as acrolein or methacrolein. A chaotropic agent may be included in the kit. The monomers may be α,β-unsaturated carbonyl monomers, such as acrylate monomers and/or acrylamide and/or N,N-dimethylacrylamide monomers, such as sodium acrylate with acrylamide, optionally with a crosslinker, such as N,N′-methylene bis(acrylamide). Optionally the kit comprises a mold or chamber for use in formation of the hydrogel comprising the sample. A suitable initiator, such as a UV initiator, or any other reagents for promoting polymer formation also may be included in the kit, typically in a separate vessel from the monomers.

### Example 1—UV Curing of Swellable Polymer

The innovation herein describes (1) a method for making swellable polyelectrolyte polymers that enable incorporation of aldehyde-reactive biomolecules during in situ polymerization using initiation with ultraviolet (UV) light, and (2) a method for using this special polymer as described in (1) to simplify workflow of expanding extracellular vesicles (EVs) using Expansion Microscopy (ExM). Non-limiting examples of ExM are described in WO 2015/127183 A2, WO 2017/027367 A1, WO 2017/027368 A1, and WO 2019/241662 A1, which are hereby incorporated by reference for their technical disclosure. The method permits retention of biomolecules after a simplified homogenization and expansion process and greatly speeds up the process of ExM enabling super-resolution optical interrogations of complex biological mechanisms involving EVs using conventional optical microscopy. Features of the innovation exemplified in the present example include, without limitation:
1. a method to embed biomolecules into a hydrogel polymer that is synthesized in situ using commercially available UV initiators to perform rapid in situ polymerization.
2. Because the polymerization reaction is initiated by UV light, this innovation simplifies the process of ExM by removing the need for heat-initiated polymerization and the gelling solution is also stable at room temperature.
3. In the case of EV samples, no homogenization is needed. Thus, the processing time can be less than 1 hour.
4. In addition, because of the nature of EVs, homogenization of these components using this innovation provides a rapid means of achieving nanoscale resolution when imaging EVs.

### UV Gel Preparation

### Monomer Solutions:

Monomer Solution 1: 10:90 DMAA:SA

| | Stock | Amount | Final |
|---|---|---|---|
| Component | concentration* | (mL) | concentration* |
| N,N-Dimethylacrylamide | 96.2 | 0.416 | 4.0 |
| (DMAA) | | | |
| Sodium acrylate (SA) | 50.0 | 6.800 | 34.0 |
| Acrylamide (AA) | 66.7 | 1.499 | 10.00 |
| N,N′-Methylenebisacrylamide | 2.0 | 0.050 | 0.01 |
| (Bis) | | | |
| Sodium chloride | | | 1.00 |
| PBS | 10x | 1 | 1x |
| Water | | | |
| Total | | 10 | |

*All concentrations in g/100 mL except PBS; final composition is 4% DMAA, 34% SA, 10% AA, 100 ppm Bis, 1% NaCl.

Storage: monomer solution was mixed at 4° C. and stored at −20° C. Storage may be at 4° C. for up to 3 months. Sodium acrylate is stored at −20° C. Initiator solutions of IRGACURE® 2959 stock solutions are best prepared immediately before use.

Gelling Solution Component Stocks: Initiator: IRGACURE® 2959 stock solution made up at 10% in Methanol.

Gelling Solution (with methacrolein): Mix the following solutions in the following order:
1. Monomer solution
2. Methacrolein solution
3. IRGACURE® 2959 initiator solution (from stock).
   The mixture should be vortexed to ensure full mixing.

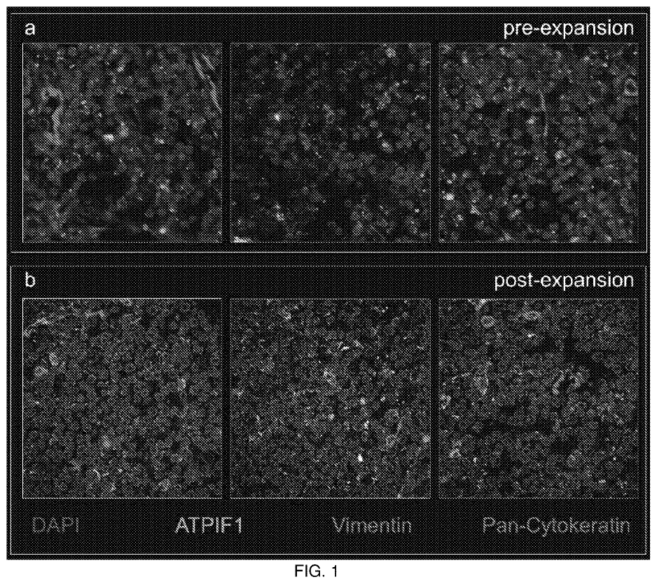

Gelling solution for EV samples and other thin tissue: Each specimen uses ~200 μl of gelling solution. For 200 μl gelling solution, mix the following:
Gelling Solution: Monomer solution (196 μl) (keep at 4° C., throughout); Initiator solution (4 μl): IRGACURE® 2959 (IRGACURE® 2959 stock at 10%, final concentration 0.2%, or 1:50 dilution), which initiates the gelling process, so it needs to be added last; and Methacrolein solution (0.2 μl): 95% Methacrolein, final concentration 0.1%.
Homogenization Buffer PD18: (can be stored as aliquots in the fridge at 25° C.): 1% (w/v) SDS; 8M Urea; 25 mM EDTA; 2×PBS; 0.1 M Tris; and 0.1 M Glycine, pH 8.
Staining Buffer C12E10: 0.1% decaethylene glycol monododecyl ether (C12E10) and 1×PBS.
Washing Buffer: 1×PBS
RNA hybridization buffer: 10% (w/v) dextran sulfate; 20% (v/v) ethylene carbonate; 2×SSC; and 0.1% (v/v) Tween20.
RNA wash buffer: 10% (v/v) ethylene carbonate; 2×SSC; and 0.1% (v/v) Tween20.
UV-ExM procedures for clinical archived tissue slides—Results are shown in FIG. 1.

### Step 1, Sample Pre-Processing

For formaldehyde-fixed paraffin-embedded (FFPE) clinical samples, place sample in a series of solutions sequentially, for 3 mins for each step: 2× xylene, 2×100% ethanol, 95% ethanol, 70% ethanol, 50% ethanol, and finally doubly deionized water. Do all the steps at room temperature (RT), 3 mins each.

For stained and mounted permanent slides, place samples briefly in xylene. Then remove coverslips carefully with appropriate tools, such as a razor blade. If the coverslip is difficult to remove, further incubate the slides in xylene at RT until the coverslip is loosened. Then wash slides in a series of solutions sequentially: 2×100% ethanol, 95% ethanol, 70% ethanol, 50% ethanol, and finally doubly deionized water. Do all the steps at RT, 3 mins each. Note: For H&E-stained slides, hematoxylin and eosin are eliminated during the expansion process.

For unfixed frozen tissue slides in optimum cutting temperature (OCT) solution (Tissue-Tek), fix the tissues for 10 min in cold acetone at −20° C. before washing with 1×PBS solution 3 times for 10 min at RT.

For already fixed, frozen clinical tissue sections, leave slides at RT for 2 mins to let the OCT, melt and then wash 3× with PBS solution at RT for 5 min each.

### Step 2, Sample Heat Treatment.

Place specimens in PD18 solution (pH 9, 100° C.) in a heat-resistant container, and then transfer the whole container to a 60° C. incubation chamber for 30 mins.

### Step 3, Pre-Expansion Labeling (Optional)

This method uses a typical staining protocol (immunofluorescence (IF)/immunohistochemistry (IHC)):
1. Treat the tissue on slides with the blocking buffer, for 1 hour at 37° C. (Note: alternatively, the incubation could be at RT for 2 hours or 4° C. overnight, according to the product manual). A hydrophobic pen can be used to draw a boundary around the tissue sections to minimize the volume of solution needed to cover the tissue.
2. Incubate the tissue with primary antibodies in staining buffer, for 3 hours at RT or 37° C., or overnight at 4° C., depending on the antibodies. (Note: suggested incubation periods and temperatures are given as a guide only. It is recommended that the user optimize these parameters for use in their own experiment. Also note, the sample needs to be placed in a humidified container during this incubation period, to prevent drying out.)
3. Wash the tissue with washing buffer, 3 times, ~10 min each, at RT.
4. Incubate the tissue on slides with secondary antibodies at a concentration of approximately 10 μg/mL together with 300 nM DAPI (if desired; DAPI can be obtained from Thermo Fisher Scientific) in the staining buffer, for at least 1 hour at RT or 37° C. (Note: suggested incubation periods and temperatures are given as a guide only. It is recommended that the user optimize these parameters for use in their own experiment), for 5 μm thick tissue (further optimization of incubation duration or temperature may be needed for thicker tissues). Note: cyanine dyes (e.g., Cy3, Cy5, Alexa 647) are not preferred on secondary antibodies since the ExM protocol is not compatible with applying these pre-polymerization. Alexa 488 is selected for green staining, Alexa 546 for orange-red staining, and Atto 647N or CF633 (the latter from Biotium) for far-red staining.
5. Wash the tissue on slides with washing buffer, 3 times, ~10 min each, at RT.
6. Cover the tissue section with 1×PBS and take pre-expansion images on a microscope so that expansion factor and thus biological units of length can be established later.

### Step 4, Mixing and Gelling

1. Prepare at least 100-fold excess volume of gelling solution (typically, 200 μL per tissue section). Incubate the sample with the gelling solution containing UV initiator at 4° C. for 1 hour.
2. Gel chambers are constructed by sandwiching the liquid mixture between a slide and a coverslip, with optional spacers on either side to make the gel thicker for improved sturdiness. Spacers are made from cut coverslips using a diamond knife. For most human tissue sections in clinical settings (5-10 μm thick), pieces of cover glass (VWR micro cover glass, 24×60 mm, No. 1 or 1.5) can be used for spacers. Avoid air bubbles trapped inside the chamber. Superglue can also be used to secure the spacers to the slide.
3. Assemble the tissue slide into a gel chamber, and then incubate under UV illumination at RT for 5 minutes.

### Step 5, Homogenization (Skipped if the Sample Contains Only Extracellular Vesicles or is Otherwise Cell-Free)

1. Take off the top cover of the gel chamber using a razor blade placed at the edge of the coverslip, sliding the blade along the coverslip side touching the gel surface and then gently using the blade to lift the coverslip off the gel surface.
2. Trim the tissue-containing gel to minimize volume, using a sharp razor blade, and cut a corner in an off-angle fashion for tracking of orientation throughout later steps (when the gel is transparent, and orientation is sometimes hard to gauge).
3. Use a razor blade to gently shave the sample off the slide into a tube containing the homogenization solution at 80° C. for 48 hours. Washing with PBS buffer three times 15 minutes each time, at room temperature (RT) and incubate at 60° C. for 30 minutes 0.1% C12E10 Solution.

### Step 6, Labeling

1. Incubate the sample at RT with staining buffer containing appropriate primary antibodies.
2. Wash the samples 3 times with washing buffer, 10 min each at RT.
3. Incubate the sample with staining buffer containing appropriate secondary antibodies or other labeling reagents at RT.

### Step 7, Expansion

1. Remove the PBS and wash the samples with excess volume of ddH2O (e.g., at least 10× the final gel volume; optionally, one can add to the water 0.002%-0.01% NaN₃ to prevent bacterial growth, although the final expansion factor is reduced by 10%), 3-5 times, for 10 minutes each time at RT. Slice expansion should reach a plateau after about the 3rd or 4th wash. Samples can also be expanded in 1:50 or 1:100 PBS to help preserve antibody labeling. Note: the expansion chamber needs to be of adequate size for the sample. You might need to trim the gel. The sample might need to be trimmed into smaller pieces if no chamber of proper size can be obtained. In general, an expanded gel containing a tissue with diameter less than 0.6 cm pre-expansion fits nicely in a glass bottom 6 well plate.
2. Gels can be immobilized with 1.5-2% low melt agarose in water to prevent drift during imaging.
   Final Step: Image with Conventional Fluorescent, Confocal Microscope, or Another Desired Microscope.

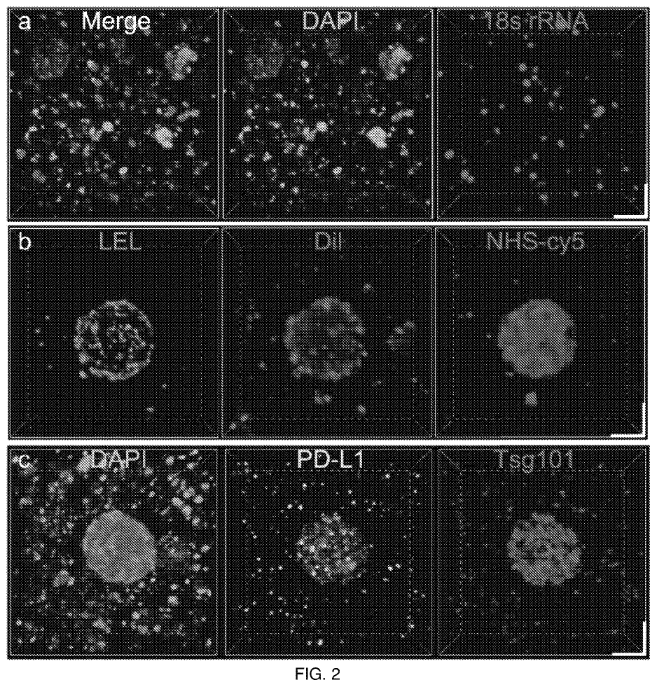

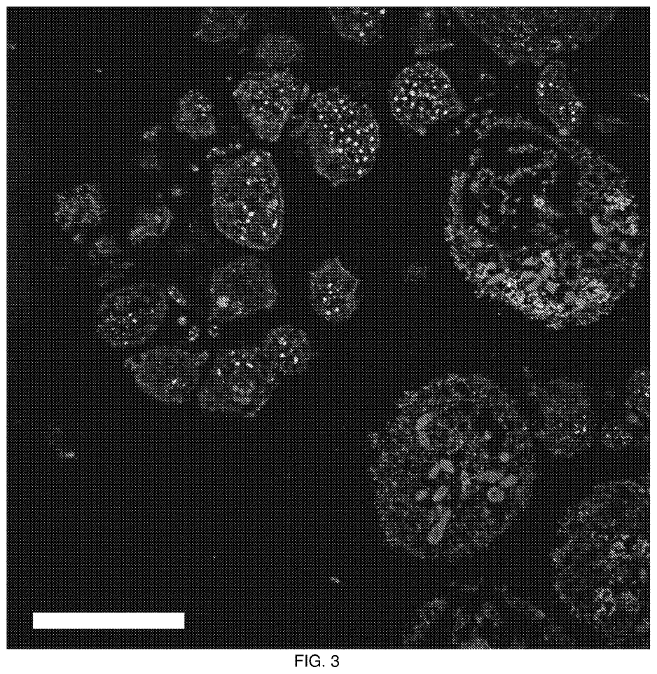

UV-EV Gelation: Results shown in FIG. 2. FIG. 3 shows platelets expanded and imaged in essentially the same manner as the EVs.

### Step 1, Mixing and Gelling

1. Prepare at least 10-fold excess volume of gelling solution (typically, 10 μL per 1 μL of EV sample).
2. Thaw EV sample on ice. Deposit 1 μL of sample on a glass slide, allow partially air dry.
3. Incubate the sample with the gelling solution containing UV initiator at 4° C. for 3 minutes.
4. Gel chambers are constructed by sandwiching the liquid mixture between a slide and a coverslip, with spacers on either side to constrain an appropriate size of the gel for imaging. Spacers are made from cut coverslips (VWR micro cover glass, 24×60 mm, No. 1 or 1.5) using a diamond knife. Avoid air bubbles trapped inside the chamber. Superglue can also be used to secure the spacers to the slide.
5. After assembly of the gel chamber, incubate the gelling mixture that contains the EV sample under UV illumination at RT from 15 to 30 minutes.
   Step 2, Labeling with RNA Fluorescence In Situ Hybridization
1. Prepare gels by incubating with RNA wash buffer for 30 minutes at RT.
2. Prepare probes by diluting in RNA hybridization buffer at a total probe concentration of 100 nM. Vortex to mix.
3. Remove the wash buffer from the gels. Add the hybridization buffer with probes onto the gels. Add enough volume to completely cover the gel to be stained (for 10 μL gel, e.g., 250 μL). Incubate overnight at 37° C.
4. Wash gels twice with excess volume (e.g., 800 μL for 10 μL gel) of RNA wash buffer at 37° C. with 30 minutes per wash.
5. Wash once with excess volume PBS at 37° C. for 30 minutes.
   Step 3, Labeling with Antibodies and Fluorescent Dyes
1. Incubate the sample at RT with staining buffer containing appropriate fluorophore-conjugated primary antibodies, and other fluorescent labels, for at least 3 hours.
2. Wash the samples 3 times with washing buffer, 10 min each at RT.

### Step 4, Expansion

1. Remove the PBS and wash the samples with excess volume of ddH2O (e.g., at least 10× the final gel volume; optionally, one can add to the water 0.002%-0.01% NaN₃ to prevent bacterial growth, although the final expansion factor is reduced by 10%), 3-5 times, for 10 minutes each time at RT. UV gel expansion should reach a plateau after about the 3rd or 4th wash. Samples can also be expanded in 1:50 or 1:100 PBS to help preserve antibody labeling. Note: the expansion chamber needs to be of adequate size for the sample. You might need to trim the gel. The sample might need to be trimmed into smaller pieces if no chamber of proper size can be obtained. In general, an expanded EV with a volume of 10 μL fits nicely in a glass bottom 6-well plate.
2. Gels can be immobilized with 1.5-2% low melt agarose in water to prevent drift during imaging.
   Final Step: Image with Conventional Fluorescent, Confocal Microscope, or Another Desired Microscope.

### Example 2—Heat and Pressure Acceleration of Homogenization

The following exemplifies a method of expediting workflow of expanding specimens using Expansion Microscopy. This method greatly speeds up the process of Expansion Microscopy, enabling super-resolution optical interrogations of complex biological mechanisms using conventional optical microscopy. Additionally, this method acts as a rapid tissue clearing protocol that preserves lipids along with other biomolecules. Unless indicated to the contrary, reference to an applied pressure is a pressure in addition to normal atmospheric pressure (that is, 1 atm).

The method allows for physically expanding the hybrid of swellable hydrogel and large tissues (or whole organs or animals). In this example, a tissue-hydrogel hybrid is incubated with a solution comprising a detergent (for example, SDS) and a chaotropic agent (for example, urea) for a certain period of time in a temperature and pressure using a pressure cooker or autoclave where proteins and other biomolecules denatured but without aggregation or entanglement with each other. This method allows for successful homogenization of mechanically strong tissue, organs, and whole organisms that are fixed with paraformaldehyde while earlier-described expansion methods cannot. For example, Ku et al. reported their failed attempt to expand paraformaldehyde-fixed tissues (see, Ku et al., Multiplexed and scalable super-resolution imaging of three-dimensional protein localization in size-adjustable tissues. Nat Biotechnol. 2016 September; 34 (9): 973-81). Due to the rapid expansion process, the processing of tissue by this method reduces processing times from days to less than a single day. This innovation also provides a novel tissue clearing protocol that retains lipids and other biomolecules while matching the refractive index of the specimen to water (n=1.33).

### Methods

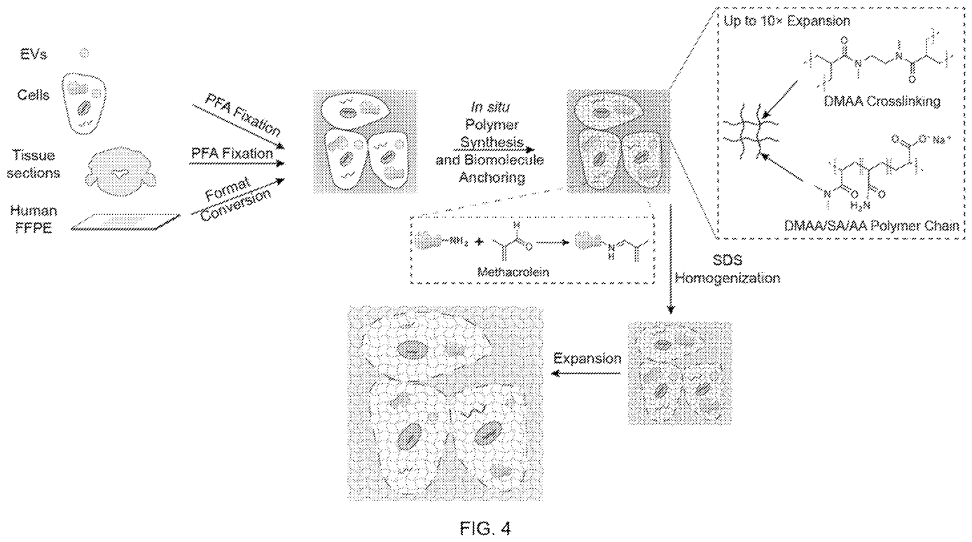

FIG. 4 provides a schematic diagram of the method provided in this Example.

### Hydrogel Preparation:

TABLE A
Monomer Solutions

| | Stock | Amount | Final |
|---|---|---|---|
| Component | concentration* | (mL) | concentration* |
| N,N-Dimethylacrylamide | 96.2 | 0.416 | 4.0 |
| (DMAA) | | | |
| Sodium acrylate (SA) | 50.0 | 6.800 | 34.0 |
| Acrylamide (AA) | 66.7 | 1.499 | 10.00 |
| N,N′-Methylenebisacrylamide | 2.0 | 0.050 | 0.01 |
| (Bis) | | | |
| Sodium chloride | | | 1.00 |
| PBS | 10x | 1 | 1x |
| Water | | | |
| Total | | 10 | |

*All concentrations in g/100 mL except PBS

The final composition ends up as 4% DMAA, 34% SA, 10% AA, 100 ppm Bis, 1% NaCl. It is noted that the concentrations of the relevant monomers may vary without significantly altering the ability to expand the tissue, for example and without limitation for the monomer components: 2-6% (v/v) DMAA, 20-40% (w/v) SA, 2-15% (w/v) AA, 50-2000 ppm (w/v) Bis.

Storage: The monomer solution was mixed at 4° C. and stored at −20° C. for long term storage. There was no impact from storing the solution at 4° C. for up to at least 3 months. Sodium acrylate is stored at −20° C. Initiator solutions of IRGACURE® 2959 stock or potassium persulfate (KPS) solutions are best prepared immediately before use.

Gelling Solution Component Stocks: IRGACURE® 2959 stock solution was made up at 10% in Methanol OR KPS stock solution made up at 5% in water.

Gelling Solution (with UV initiator): Mix the following solutions in the following order:
1. Monomer solution;
2. Methacrolein solution; and
3. IRGACURE® 2959 initiator solution (from stock).

Gelling Solution (with thermal initiator): Mix the following solutions in the following order:
1. Monomer solutions
2. TEMED accelerator (from stock, below)
3. 4HT inhibitor solution (from stock, below)
4. Ammonium persulfate (APS) initiator solution (from stock, below)
5. Methacrolein solution.

The initiator solution is added last, to prevent premature gelation. The mixture is vortexed to ensure full mixing.

Gelling solution #1: for UV-cured samples (for 200 μL): Monomer solution (196 μl) (keep at 4° C., throughout); Initiator solution (4 μl): IRGACURE® 2959 (IRGACURE® 2959 stock at 10%, final concentration 0.2%, or 1:50 dilution), which initiates the gelling process, so it needs to be added last; and Methacrolein solution (0.2 μl): 95% Methacrolein, final concentration 0.1%.

Gelling solution #2: for thin thermally cured samples (for 200 μL): Monomer solution (190 μl) (keep at 4° C., throughout, to prevent premature gelation); Accelerator solution (2 μl): TEMED (TEMED stock solution made up at 10% in water, final concentration 0.1%, or 1:100 dilution), which accelerates radical generation by KPS; Initiator solution (8 μl): KPS (KPS stock at 5%, final concentration 0.2%, or 1:25 dilution), which initiates the gelling process, so it needs to be added last; and Methacrolein solution (0.2 μl): 95% Methacrolein, final concentration 0.1%.

Gelling solution #3: for thick thermally cured samples-incubation step (for 200 μL): Monomer solution (176 μl) (keep at 4° C., throughout, to prevent premature gelation); Inhibitor solution (4 μl): 4-hydroxy-TEMPO (4HT stock solution made up at 0.5% in water, final concentration 0.01%, thus, dilution ratio is 1:50), which inhibits gelation to enable diffusion into tissue sections; Initiator solution (20 μl): KPS (KPS stock at 5%, final concentration 0.5%, or 1:10 dilution), which initiates the gelling process, so it needs to be added last; and Methacrolein solution (0.2 μl): 95% Methacrolein, final concentration 0.1%.

Gelling solution #4: for thick thermally cured samples (for 200 μL): Monomer solution (180 μl) (keep at 4° C., throughout, to prevent premature gelation); Initiator solution (20 μl): KPS (KPS stock at 5%, final concentration 0.5%, or 1:10 dilution), which initiates the gelling process, so it needs to be added last; and Methacrolein solution (0.2 μl): 95% Methacrolein, final concentration 0.1%.

Homogenization Buffer PD18: (can be stored as aliquots in the fridge at 25° C.): 1% (w/v) SDS, 8M Urea, 25 mM EDTA, 2×PBS, 0.1 M Tris, and 0.1 M Glycine, pH 8.

Homogenization Buffer PD14: (can be stored as aliquots in the fridge at 25° C.): 1% (w/v) SDS; 8M Urea; 330 mM EDTA; 0.1 M Tris; and 0.1 M Glycine, pH 8.

Staining Buffer C12E10: 0.1% decaethylene glycol monododecyl ether (C12E10) and 1×PBS. For thick samples, this buffer may be 0.1% decaethylene glycol monododecyl ether (C12E10) and 10×PBS.

Washing Buffer: 1×PBS.

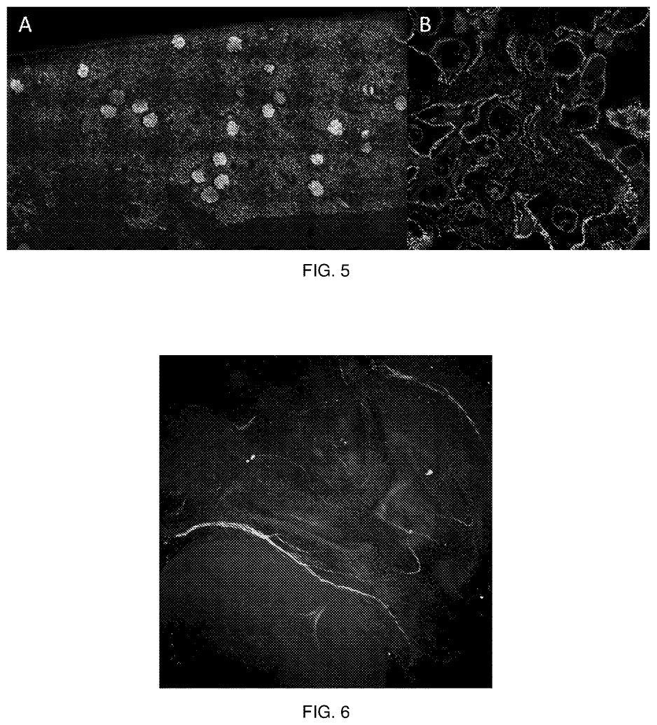

Rapid-Magnify procedures for clinical archived tissue slides (Results shown in FIG. 5).

### Step 1, Sample Pre-Processing:

For formaldehyde-fixed paraffin-embedded (FFPE) clinical samples, place sample in a series of solutions sequentially, for 3 mins for each step: 2×xylene, 2×100% ethanol, 95% ethanol, 70% ethanol, 50% ethanol, and finally doubly deionized water. Do all the steps at room temperature (RT), 3 mins each.

For stained and mounted permanent slides, place samples briefly in xylene. Then remove coverslips carefully with appropriate tools, such as a razor blade. If the coverslip is difficult to remove, further incubate the slides in xylene at RT until the coverslip is loosened. Then wash slides in a series of solutions sequentially: 2×100% ethanol, 95% ethanol, 70% ethanol, 50% ethanol, and finally doubly deionized water. Do all the steps at RT, 3 mins each.

Note: For H&E-stained slides, hematoxylin and eosin are eliminated during the expansion process.

For unfixed frozen tissue slides in optimum cutting temperature (OCT) solution (Tissue-Tek), fix the tissues for 10 min in cold acetone at −20° C. before washing with 1×PBS solution 3 times for 10 min at RT.

For already fixed, frozen clinical tissue sections, leave slides at RT for 2 mins to let the OCT, melt and then wash 3× with PBS solution at RT for 5 min each.

### Step 2, Sample Heat Treatment (Optional, Only Needed if Staining Pre-Expansion).

Place specimens in PD18 solution (pH 9, 100° C.) in a heat-resistant container, and then transfer the whole container to a 60° C. incubation chamber for 30 mins.

Step 3, Pre-Expansion Labeling (Optional) this is Like a Typical Staining Protocol (Immunofluorescence (IF)/Immunohistochemistry (IHC)):
1. Treat the tissue on slides with the blocking buffer, for 1 hour at 37° C. (Note: alternatively, the incubation could be at RT for 2 hours or 4° C. overnight, according to the product manual.) A hydrophobic pen can be used to draw a boundary around the tissue sections to minimize the volume of solution needed to cover the tissue.
2. Incubate the tissue with primary antibodies in staining buffer, for 3 hours at RT or 37° C., or overnight at 4° C., depending on the antibodies. (Note: suggested incubation periods and temperatures are given as a guide only. It is recommended that the user optimize these parameters for use in their own experiment. Also note, the sample needs to be placed in a humidified container during this incubation period, to prevent drying out.)
3. Wash the tissue with washing buffer, 3 times, ~10 min each, at RT.
4. Incubate the tissue on slides with secondary antibodies at a concentration of approximately 10 μg/mL together with 300 nM DAPI (if desired; DAPI can be obtained from Thermo Fisher Scientific) in the staining buffer, for at least 1 hour at RT or 37° C. (Note: suggested incubation periods and temperatures are given as a guide only. The user may optimize these parameters for use in their own experiment), for 5 μm thick tissue (further optimization of incubation duration or temperature may be needed for thicker tissues). Note: Do not use cyanine dyes (Cy3, Cy5, Alexa 647) on your secondary antibodies (since the ExM protocol is not compatible with applying these pre-polymerization). The following may be used for staining: Alexa 488 for green staining, Alexa 546 for orange-red staining, and Atto 647N or CF633 (the latter from Biotium) for far-red staining.
5. Wash the tissue on slides with washing buffer, 3 times, ~10 min each, at RT.
6. Cover the tissue section with 1×PBS and take pre-expansion images on a microscope so that expansion factor and thus biological units of length can be established later.
Step 4, Mixing and Gelling
1. Prepare at least 100-fold excess volume of gelling solution (typically, 200 μL per tissue section). Incubate the sample with the gelling solution #1 or gelling solution #2 at 4° C. for 30 minutes.
2. Gel chambers are constructed by sandwiching the liquid mixture between a slide and a coverslip, with optional spacers on either side to make the gel thicker for improved sturdiness. Spacers are made from cut coverslips using a diamond knife. For most human tissue sections in clinical settings (5-10 μm thick), pieces of cover glass (VWR micro cover glass, 24×60 mm, No. 1 or 1.5) can be used for spacers. Avoid air bubbles trapped inside the chamber. Superglue can also be used to secure the spacers to the slide.
3. For UV cured samples: Assemble the tissue slide into a gel chamber, and then incubate under UV illumination at RT for 5 minutes.
   For thermally cured samples: Assemble the tissue slide into a gel, and then incubate at 37° C. in a humidified environment for 1 hour, followed by incubation at 60° C. in a humidified environment for 1 hour.

### Step 5, Homogenization

1. Take off the top cover of the gel chamber using a razor blade placed at the edge of the coverslip, sliding the blade along the coverslip side touching the gel surface and then gently using the blade to lift the coverslip off the gel surface.
2. Trim the tissue-containing gel to minimize volume, using a sharp razor blade, and cut a corner in an off-angle fashion for tracking of orientation throughout later steps (when the gel is transparent, and orientation is sometimes hard to gauge).
3. Use a razor blade to gently shave the sample off the slide into a tube containing the homogenization solution. Place the tube into an autoclave or pressure cooker and incubate for 65 minutes at 12 PSI. Washing with PBS buffer three times 15 minutes each time, at room temperature (RT, e.g., 25° C.) and incubate at 60° C. for 30 minutes 0.1% C12E10 Solution.

### Step 6, Labeling

1. Incubate the sample at RT with staining buffer containing appropriate primary antibodies.
2. Wash the samples 3 times with washing buffer, 10 min each at RT.
3. Incubate the sample with staining buffer containing appropriate secondary antibodies or other labeling reagents at RT.

### Step 7, Expansion

1. Remove the PBS and wash the samples with excess volume of ddH2O (e.g., at least 10× the final gel volume; optionally, one can add to the water 0.002%-0.01% NaN₃ to prevent bacterial growth, although the final expansion factor is reduced by 10%), 3-5 times, for 10 minutes each time at RT. Slice expansion should reach a plateau after about the 3rd or 4th wash. Samples can also be expanded in 1:50 or 1:100 PBS to help preserve antibody labeling. Note: the expansion chamber needs to be of adequate size for the sample. The sample might need to be trimmed into smaller pieces if no chamber of proper size can be obtained. In general, an expanded gel containing a tissue with diameter less than 0.6 cm pre-expansion fits nicely in a glass bottom 6 well plate.
2. Gels can be immobilized with 1.5-2% low melt agarose in water to prevent drift during imaging.
   Final Step: Image with Conventional Fluorescent, Confocal Microscope, or Another Desired Microscope.

Rapid Magnify for Expansion and Clearing of Zebrafish Embryos: (Results shown in FIG. 6)

### Step 1, Mixing and Gelling

1. Incubate the zebrafish embryo with the gelling solution #3 at 4° C. for 24 hours.
2. Replace the gelling solution with fresh gelling solution #3 and incubate at 4° C. for 24 hours.
3. Incubate the zebrafish embryo with the gelling solution #4 at 4° C. for 1 hours.
4. Gel chambers are constructed by sandwiching the liquid mixture between a slide and a coverslip, with optional spacers on either side to make the gel thicker for improved steadiness. Spacers are made from cut coverslips using a diamond knife. For most human tissue sections in clinical settings (5-10 μm thick), pieces of cover glass (VWR micro cover glass, 24×60 mm, No. 1 or 1.5) can be used for spacers. Avoid air bubbles trapped inside the chamber.
5. Assemble the tissue slide into a gel chamber, and then incubate at 37° C. in a humidified environment for 1 hour, followed by incubation at 60° C. in a humidified environment for 1 hour.

### Step 2, Homogenization

1. Take off the top cover of the gel chamber using a razor blade placed at the edge of the coverslip, sliding the blade along the coverslip side touching the gel surface and then gently using the blade to lift the coverslip off the gel surface.
2. Trim the tissue-containing-gel to minimize volume, using a sharp razor blade, and cut a corner in an off-angle fashion for tracking of orientation throughout later steps (when the gel is transparent and orientation sometimes hard to gauge).
3. Use a razor blade to gently shave the sample off the slide into a tube containing PD14 and incubate at room temperature for at least 3 hours. Transfer the specimen to an autoclave or pressure cooker at, e.g., 3 PSI for 50 minutes at 105° C. or 12 PSI for 45 minutes at 117° C. Followed by washing with PBS buffer three times 15 minutes each time, at RT.

### Step 3, Labeling

1. Wash the samples multiple times with 1×PBS solution, 10 min each wash at RT.
2. Incubate the sample with 1×PBS solution containing appropriate primary antibodies overnight at RT.
3. Wash the samples several times with 1×PBS solution.
4. Incubate the sample with 1×PBS solution containing appropriate secondary antibodies or another labeling reagent overnight at RT.

### Step 4, Expansion

1. Wash the samples once with 1×PBS buffer for 10 min at RT and stain with 300 nM DAPI in PBS buffer for 20 mins at RT, then wash them once with 1×PBS for 10 min at RT.
2. For expansion, remove the PBS and wash the samples with excess volume of ddH₂O (e.g, at least 10× the final gel volume; optionally, one can add to the water 0.002%-0.01% NaN₃ to prevent bacterial growth, although the final expansion factor is reduced by 10%), 3-5 times, for 10 minutes each time at RT. Slice expansion should reach a plateau after about the 3^{rd} or 4^{th} wash. Note: the expansion chamber needs to be of adequate size for the sample. You might need to trim the gel. The sample might need to be trimmed into smaller pieces if no chamber of proper size can be obtained. In general, an expanded gel containing a tissue with diameter less than 0.6 cm pre-expansion fits nicely in a glass bottom 6 well plate.
3. Gels can be immobilized with 1.5-2% low melt agarose in water to prevent drift during imaging.
   Final Step: Image with Conventional Fluorescent, Confocal Microscope, or Other Desired Scopes.

### Example 3. Rapid Magnify Expansion and Clearing of Whole Organs

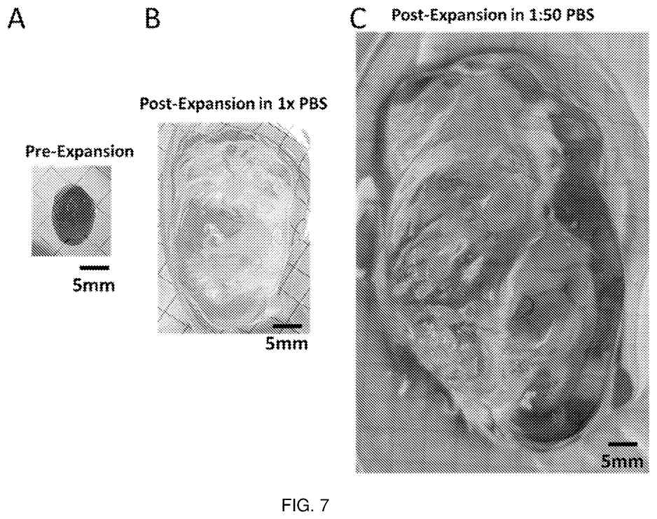

(Results shown in FIG. 7). Reagents are described in Example 2.

### Step 1, Mixing and Gelling

1. Incubate the organ with the gelling solution #3 at 4° C. for 24 hours.
2. Replace the gelling solution with fresh gelling solution #3 and incubate at 4° C. for 24 hours.
3. Replace the gelling solution with fresh gelling solution #3 and incubate at 4° C. for 24 hours.
4. Replace the gelling solution with fresh gelling solution #3 and incubate at 4° C. for 24 hours.
5. Incubate the organ with the gelling solution #4 at 4° C. for 1 hours.
6. Place the tissue in a 6—, 12-, or 24-well plate (depending on the size of the organ) and cover with a small amount of gelling solution #4. Add enough mineral oil to cover the tissue. Incubate at 37° C. in a humidified environment for 1 hour, followed by incubation at 60° C. in a humidified environment for 2 hours.

### Step 2, Homogenization

1. Remove the mineral oil from the specimen. Wash the surface of the specimen 2 times in 10×PBS to remove excess mineral oil.
2. Remove the specimen from the well. Trim the tissue-containing-gel to minimize volume, using a sharp razor blade.
3. Use a soft paintbrush to move the specimen into a vessel of sufficient size to contain it, such as a 50 ml conical. to gently shave the sample off the slide into a tube containing PD18 and incubate at RT for 8 hours. Transfer the specimen an autoclave or pressure cooker and incubate at, e.g., 3 PSI for 8 hours or 12 PSI for 2 hours. Followed by washing with PBS buffer three times 15 minutes each time, at RT.

### Step 3, Labeling

1. Wash the samples multiple times with 1×PBS solution, 10 min each wash at RT.
2. Incubate the sample with 1×PBS solution containing appropriate primary antibodies overnight at RT.
3. Wash the samples several times with 1×PBS solution.
4. Incubate the sample with 1×PBS solution containing appropriate secondary antibodies or another labeling reagent overnight at RT.

### Step 4, Expansion

1. Wash the samples once with 1×PBS buffer for 10 min at RT and stain with 300 nM DAPI in PBS buffer for 20 mins at RT, then wash them once with 1×PBS for 10 min at RT.
2. For expansion, remove the PBS and wash the samples with excess volume of ddH2O (e.g., at least 10× the final gel volume; optionally, one can add to the water 0.002%-0.01% NaN₃ to prevent bacterial growth, although the final expansion factor is reduced by 10%), 3-5 times, for 10 minutes each time at RT. Slice expansion should reach a plateau after about the 3rd or 4th wash. Note: the expansion chamber needs to be of adequate size for the sample. You might need to trim the gel. The sample might need to be trimmed into smaller pieces if no chamber of proper size can be obtained. In general, an expanded gel containing a tissue with diameter less than 0.6 cm pre-expansion fits nicely in a glass bottom 6 well plate.
3. Gels can be immobilized with 1.5-2% low melt agarose in water to prevent drift during imaging.
   Final Step: Image with Conventional Fluorescent, Confocal Microscope, or Other Desired Scopes.

The present invention has been described with reference to certain exemplary embodiments, dispersible compositions and uses thereof. However, it will be recognized by those of ordinary skill in the art that various substitutions, modifications, or combinations of any of the exemplary embodiments may be made without departing from the spirit and scope of the invention. Thus, the invention is not limited by the description of the exemplary embodiments, but rather by the appended claims as originally filed.

1. A method of preparing a cell or tissue sample for microscopy, comprising:
permeating the cell or tissue sample with a polymer monomer composition comprising an α,β-unsaturated carbonyl monomer for producing a water-swellable (co)polymer and a polymerization initiator compound;
polymerizing the polymer monomer composition to produce a water-swellable polymer;
after formation of the water-swellable polymer and before swelling the sample, homogenizing mechanical properties of the cell or tissue sample in a homogenization mixture comprising a chaotropic agent at a pressure greater than 1 atm and at a temperature over 100° C.; and
swelling the water-swellable polymer to expand the cell or tissue sample.

2. The method of claim 1, wherein the polymer monomer composition further comprises an enal able to polymerize with the α,β-unsaturated carbonyl monomer; and polymerizing the polymer monomer composition with the enal to form a swellable material containing the cell or tissue sample, resulting in covalent linking of the enal to both the swellable material and a biomaterial in the sample.

3. The method of claim 32, wherein the enal comprises acrolein or methacrolein.

4. The method of claim 3, wherein the enal comprises a compound having the structure 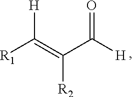
where R₁ and R₂ are, independently: H, C₁-C₃ alkyl, C₁-C₃ haloalkyl, C₁-C₃ alkyl-aryl, or C₁-C₃ halo alkyl-aryl.

5. (canceled)

6. The method of claim 1, wherein the polymer monomer composition comprises a crosslinker, such as N,N′-methylene-bis(acrylamide), at a concentration of 0.01 g/100 ml to 5 g/100 ml.

7. (canceled)

8. The method of claim 1, wherein the homogenization mixture further comprises a protease, a surfactant, 2-mercaptoethanol and/or DTT, and/or a chelating agent.

9. (canceled)

10. The method of claim 1, wherein the polymerization inhibitor compound is a UV photoinitiator.

11. (canceled)

12. The method of claim 1, wherein the sample is a whole organism or embryo.

13. The method of claim 1, wherein the sample comprises a plurality of organs of an organism.

14. The method of claim 1, wherein the cell or tissue sample is a tissue section.

15. The method of claim 14, wherein the tissue section is provided mounted with a coverslip and/or paraffin-embedded, and the method further comprises pre-processing the tissue section with an organic solvent, such as xylene, to remove the coverslip and/or paraffin from the sample and replacing the organic solvent with an aqueous solution.

16. (canceled)

17. The method of claim 1, further comprising, labeling a biomolecule of the sample with a detectable ligand, wherein the detectable ligand is an antibody, a nucleic acid, an immunofluorescence label, or an immunochemistry label.

18-20. (canceled)

21. The method of claim 1, wherein during swelling, the sample swells isotropically, thereby maintaining the relative spatial relationship of biomolecules in the sample.

22. The method of claim 1, wherein the cell or tissue sample is fixed in a fixative, further comprising removing the fixative from the sample by exposing the sample to a solvent for the fixative prior to permeating the cell or tissue sample with the polymer monomer composition.

23. The method of claim 1, comprising:
permeating the cell or tissue sample with a polymer monomer composition comprising sodium acrylate, acrylamide, N,N′-methylene bis(acrylamide), and acrolein or methacrolein;
polymerizing the polymer monomer composition within the sample to form a swellable material, resulting in covalent linking of the acrolein or methacrolein to both the swellable material and biomaterials in the sample;
homogenizing the mechanical properties of the cell or tissue sample in a homogenization mixture comprising a chaotropic agent at a pressure greater than 1 atm and at a temperature over 100° C.; and
hydrating the sample to cause the swellable material to physically expand.

24. The method of claim 2, wherein the polymer monomer composition comprises from 0.5M to 6M of α,β-unsaturated carbonyl monomer and/or from 0.01 g/100 mL to 10 g/100 mL of the enal.

25-27. (canceled)

28. The method of claim 1, wherein the homogenization is performed is an autoclave at a pressure ranging from 3-15 psi above ambient atmospheric pressure and at a temperature ranging from 120° C. to 135° C.

29. (canceled)

30. The method of claim 1, wherein the homogenization is conducted for a length of time, at a pressure, and at a temperature such that detectable features of the tissue or cell to be evaluated, such as structural, antigenic, or chemical features of the tissue or cell to be evaluated, are preserved.

31-32. (canceled)

33. A kit for use in expansion microscopy, comprising, in packaging, an α,β-unsaturated carbonyl monomer for producing a water-swellable (co)polymer, a chaotropic agent, such as urea, and a polymerization initiator, such as a UV photoinitiator, packaged in one or more vessels, and optionally, a microscope slide and/or a form for use in forming a water-swellable sample comprising the monomer, for expansion microscopy.

34. A method of producing a high-resolution microscopic image of a cell or tissue sample, comprising:
permeating the cell or tissue sample with a polymer monomer composition comprising an α,β-unsaturated carbonyl monomer for producing a water-swellable (co)polymer and a polymerization initiator compound;
polymerizing the polymer monomer composition to produce a water-swellable polymer within the sample;
after formation of the water-swellable polymer, homogenizing mechanical properties of the cell or tissue sample in a homogenization mixture comprising a chaotropic agent at a pressure greater than 1 atm and at a temperature over 100° C.;
swelling the water-swellable polymer to physically expand the cell or tissue sample; and
imaging the expanded cell or tissue sample.
